(19) United States
(12) Patent Application Publication
(10) Pub. No.: US 2023/0135236 A1
(43) Pub. Date: May 4, 2023

(54) Optical Signal Processing Device

(71) Applicant: Nippon Telegraph and Telephone Corporation, Tokyo (JP)

(72) Inventors: Mitsumasa Nakajima, Musashino-shi, Tokyo (JP); Toshikazu Hashimoto, Musashino-shi, Tokyo (JP); Kenji Tanaka, Musashino-shi, Tokyo (JP)

(21) Appl. No.: 17/912,456

(22) PCT Filed: Apr. 7, 2020
(86) PCT No.: PCT/JP2020/015727

§ 371 Date: Sep. 16, 2022

(51) Int. Cl. G06E 1/02; G06N 3/067

(52) U.S. Cl. CPC G06E 1/02; G06N 3/0675

(57) ABSTRACT

There is provided an optical signal processing device that constitutes a neural network, characterized by including an optical computation device including: a light modulator that converts an electric signal into an optical signal; an optical circuit that converts the optical signal through computation processing on the optical signal which has been modulated by the light modulator, the optical circuit including an optical medium with a controlled distribution of a refractive index corresponding to a weight in the neural network; and a light receiver that obtains an output signal by receiving the optical signal which has been converted by the optical circuit.

### TECHNICAL FIELD

The present disclosure relates to an optical signal processing device, and particularly relates to a technique in which an optical element is used in a layer configuration of a neural network.

### BACKGROUND ART

Machine learning that uses a deep neural network (hereinafter occasionally referred to as “DNN”) which models information processing by a brain is drawing attention. It is known that a network configuration composed of relatively deep layers, called residual network (hereinafter occasionally referred to as “ResNet”), exhibits good performance as a configuration of the DNN (NPL 1). Further, there is proposed a neural ordinary differential equation network (hereinafter occasionally referred to as “ODE-Net”), which expresses computation in each layer of the ResNet as a continuous limit (NPL 2). This network configuration can improve the memory efficiency and the network performance.

While the neural networks such as the ResNet and the ODE-Net discussed above are widely applied to data learning and processing, the neural networks occasionally require time and electric power, since synapse connections are significantly increased along with an increase in the number of layers and the number of neurons. In order to address such an issue, a DNN processing circuit (hardware dedicated to DNN processing in which an optical technology is used) in which an optical circuit is used is proposed (NPL 3). This circuit generally controls the weights between the neurons described above using optical gate circuits such as Mach-Zehnder interferometers (MZIs). The circuit is advantageous in terms of electric power and computation speed, since computation is performed only through propagation of light waves.

### CITATION LIST

### Non Patent Literature

[NPL 1] K. He, X. Zhang, S. Ren, and J. Sun. Deep residual learning for image recognition. In Proc. IEEE Conf. Comp. Vis. Patt. Recogn., 2016.
T. Q. Chen, Y. Rubanova, J. Bettencourt, and D. K. Duvenaud, “Neural ordinary differential equations,” in Advances in Neural Information Processing Systems, 2018, pp. 6571-6583.
Y. Shen, N. C. Harris, S. Skirlo, M. Prabhu, T. Baehr-Jones, M. Hochberg, X. Sun, S. Zhao, H. Larochelle, D. Englund et al., “Deep learning with coherent nanophotonic circuits,” Nat. Photonics 11, (2017) 441-446.
S. Molesky, Z. Lin, A. Y. Piggott, W. Jin, J. Vuckovic and A. W. Rodriguez, “Inverse design in nanophotonics,” Nature Photonics 12, (2018) 659-670.
Y. Sakamaki, T. Saida, T. Hashimoto, and H. Takahashi, “New optical waveguide design based on wavefront matching method,” J. Lightw. Technol., November 2007, vol. 25, no. 11, pp. 3511-3518.
L. Ruthotto, E. Haber, “Deep Neural Networks Motivated by Partial Differential Equations,” Journal of Mathematical Imaging and Vision, Sep. 18 (2019), pp. 1-9.
Y. LeCun, “A theoretical framework for back-propagation,” Proc. the 1988 Connectionist Models Summer School, (1988) pages 21-28.

### SUMMARY OF THE INVENTION

However, the size of the MZI elements is generally larger than 100 μm², and therefore it is not easy to form a large number of weight control circuits. For example, NPL 3 describes a configuration that has 56 MZIs in an area of about 1 mm by 1 mm, the number of neurons being four neurons by four layers. The number of weights in a typical DNN for use in image recognition etc. amounts to a value that is larger than 10⁷ (the number of weights in a typical DNN>10⁷), and thus the configuration in which gate elements are used described above has an issue of scalability.

In order to address the above issue, the present disclosure implements a configuration of a DNN by locally controlling the distribution of the refractive index by using the analogy (analogous relationship) between light propagation and propagation of signals in the DNN. The local distribution of the refractive index can be controlled in the order of several tens of nanometers to micrometers, and thus it is possible to apply about 10⁶ to 10⁸ weights in an area of 1 mm by 1 mm.

In order to address the above issue, an optical signal processing device according to an aspect constitutes a neural network, and is characterized by including an optical computation device including: a light modulator that converts an electric signal into an optical signal; an optical circuit that converts the optical signal through computation processing on the optical signal which has been modulated by the light modulator, the optical circuit including an optical medium with a controlled distribution of a refractive index corresponding to a weight in the neural network; and a light receiver that obtains an output signal by receiving the optical signal which has been converted by the optical circuit.

With an embodiment of the present disclosure, it is possible to impart high scalability to hardware based on a DNN processing technology in which an optical circuit is used.

### BRIEF DESCRIPTION OF DRAWINGS

FIG. 1 illustrates the configuration of optical neural signal processing according to a first embodiment.

FIG. 2 illustrates the configuration of optical neural signal processing according to a second embodiment.

FIG. 3(a) is a schematic view of learning based on WFM, FIG. 3(b) illustrates an ordinary neural network, and FIG. 3(c) illustrates a neural network with use of WFM update rules.

FIG. 4 illustrates the configuration of optical neural signal processing according to the second embodiment.

FIG. 5 illustrates the configuration of optical neural signal processing according to a third embodiment.

FIGS. 6(a) to 6(c) illustrate examples of verification of learning through simulation.

### DESCRIPTION OF EMBODIMENTS

Embodiments of the present disclosure will be described below with reference to the drawings.

### First Embodiment

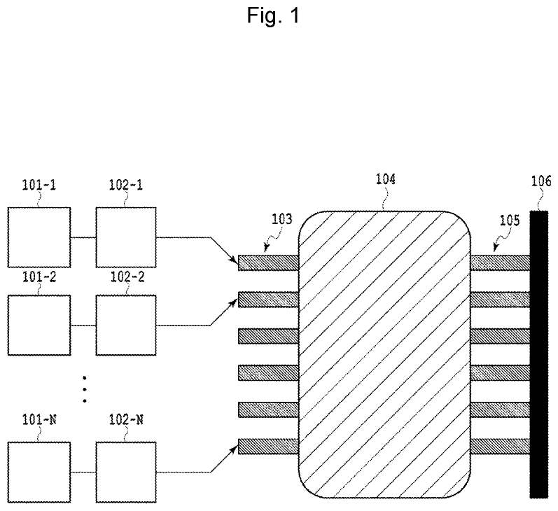

A first embodiment of the present invention will be described with reference to FIG. 1. Light emitted from light sources 101-N (natural number) is modulated in one or both of the intensity and phase values of light waves by light modulators (light modulation means) 102-N (natural number). Input information is expressed in this manner. Data having a plurality of dimensions such as image information can be supported by using a combination of the degrees of freedom of light such as time multiplexing, wavelength multiplexing, spatial multiplexing, and polarization multiplexing. The configuration of input light sources is varied (a number of light sources are arranged, the number corresponding to the number of wavelengths and the number for spatial multiplexing) in accordance with the multiplex system, and this can be achieved by using a technique commonly used in optical communication. While FIG. 1 illustrates a case where an optical signal of a single wavelength is spatially multiplexed by way of example, any multiplex system may also be used.

The modulated optical signals are led to an optical circuit 104, which includes an optical medium with a controlled refractive index distribution, via light propagation units 103. The optical medium is a two-dimensional waveguide with a controlled refractive index distribution in a propagation surface. Optical computation is performed in this circuit, and the result of the optical computation is led to a light reception unit 106 via light propagation units 105 provided at an output end. An optical fiber array, an optical waveguide formed in the optical circuit 104, etc., for example, can be used as the light propagation units 103 and 105. A photodiode array etc. may be used as the light reception unit 106. A component may be provided that measures not only the light intensity but also the phase and the polarization direction by causing a coherent light source to interfere with the light reception unit. In addition, a component may be provided that measures an optical signal for each wavelength using a wavelength separation element. Consequently, it is possible to separate light multiplexed by the variety of systems discussed earlier, and to also impart a plurality of dimensions of degrees of freedom to output data.

The optical circuit 104 which controls the refractive index distribution determines the refractive index distribution by any method during manufacture, and may either be configured not to update the refractive index distribution thereafter, or be configured to dynamically change the refractive index distribution. The former circuit achieves a desired refractive index by performing learning of a neural network in the circuit design and manufacture processes. Consequently, the circuit can be used as an inference signal processing device that makes an inference. The latter circuit can also execute learning, to be discussed later, by dynamically updating the refractive index.

Examples of the method of determining the refractive index distribution in the device manufacture stage include a method in which the difference in the refractive index between air and the material is used, by controlling the shape of a waveguide by processing such as etching (e.g. forming a vacant hole etc.) as described in NPL 4, for example. Alternatively, the difference in the refractive index from a material of a different composition of a base material in the optical medium, rather than air, may be used as described in NPL 5. In the case where the refractive index distribution is determined by the composition of the material in this manner, the weights are typically restricted to two values etc. As described below, the real part and the imaginary part of the refractive index may be controlled. However, the effect that the theoretical computation loss is brought to zero can be achieved by controlling only the real part and making the imaginary part stationary at zero (or as close as possible to zero). In order to achieve this, a material that causes little loss for input waves (e.g. SiOₓ glass or Si for light in the 1.5 μm band) may be used as the base material, and the refractive index distribution may be controlled by the method discussed earlier.

The method of dynamically updating the refractive index can be achieved by using elements such as liquid crystals as a waveguide constituting material, applying a voltage to an electrode disposed on a matrix to locally induce variations in the refractive index through rotation etc. of liquid crystal chains, and controlling the distribution of the refractive index by a method to be discussed later, for example. Besides the liquid crystal materials, non-linear elements such as LiNbO₃ and (Pb₁₋ₓ, Laₓ)ZrTiO₃ may also be used as the constituting material.

### Analogy

In the present embodiment, the optical circuit is constituted using the analogy (analogous relationship) between light propagation in the optical circuit 104 and signal propagation in the DNN. This analogy will be described below.

Regarding the signal propagation in the DNN, computation for the L-th layer in the ResNet proposed in NPL 1 is represented by the following formula.

x(L+1)=x(L)+f[x(L),θ] (1)

In the formula (1), x indicates the state of a hidden layer, θ indicates a learning weight, and f indicates a non-linear function.

NPL 2 indicates an expression of the continuous limit of the formula (1), and indicates that the expression can be indicated by the following formula.

$$\frac{dx ( l )}{dl} = f [ x ( l ) , θ , l ] \qquad ( 2 )$$

In the formula (2), 1 is the number of continuous layers. The ODE-Net, in which layer computation is expressed by the formula (2), can achieve performance equivalent to that of the ResNet, and improve the memory efficiency.

The idea that computation of a convolutional layer in the DNN can be expressed by a partial differential equation (NPL 6) is introduced.

According to this idea, a kernel filter K(θ) in convolution can be expressed as follows.

$$K ( θ ) = {α}_{1} ( θ ) - \frac{\partial }{\partial x} {α}_{2} ( θ ) - \frac{{\partial }^{2}}{\partial {x}^{2}} {α}_{3} ( θ ) \qquad ( 3 )$$

In contrast to the signal propagation in the DNN described above, a Schrodinger equation introduced for light propagation in a planar optical circuit can be expressed by the following formula (4).

$$\frac{d ψ ( x , z )}{dz} = - jH ψ ( x , z ) \qquad ( 4 )$$

In the formula (4), j indicates an imaginary number, x, z indicate the coordinate in the waveguide, and Ψ(x,z) indicates the optical electric field. H corresponds to a Hamiltonian operator, which is expressed by the following formula in the case where the system is linear (in the absence of non-linearity such as the Kerr effect).

$${H}_{L} = \frac{1}{2 {kn}_{r}} \{ \frac{{\partial }^{2}}{\partial {x}^{2}} + V ( x , z ) \} \qquad ( 5 )$$

In the formula (5), nᵣ is the reference refractive index of the waveguide. In the present embodiment, the refractive index of the clad of the waveguide can be used as the reference refractive index. V corresponds to a local potential field at the coordinate (x,z), and is indicated as follows.

V(x,z)=k²(n(x,z)−nᵣ)≡k²Δn (6)

In the formula (6), k is the wave number, n(x,z) is the local refractive index, and Δn is the difference between the local refractive index and the reference refractive index.

When V(x,z) in the formula (6) is substituted into the formula (5) and the resulting formula is substituted into the formula (4), the following formula (7) is obtained.

$$\frac{d ψ ( x , z )}{dz} = - j \frac{1}{2 {kn}_{r}} ( \frac{{\partial }^{2}}{\partial {x}^{2}} + {k}^{2} Δ n ( x , z ) ) ψ ( x , z ) \qquad ( 7 )$$

The formula (3) for signal propagation in the DNN described above represents conversion in the convolutional layer, and the formula (7) for optical signal propagation in the optical circuit represents conversion in the propagation. When these formulas are contrasted with each other, the terms of a secondary differentiation 1/2knᵣ·α²/αx² and a constant 1/2knᵣ·k²Δn(x,z) in the formula (7) correspond to the terms of a secondary differentiation α₃(θ)α²/αx² and a constant α₁(θ), respectively, in the formula (3). This indicates that the conversion computation in the light propagation circuit is expressed in the same manner as filter computation in the convolutional layer in the DNN.

θ in the formula (3) is the weight, and the function of the weight is achieved by the local refractive index n(x,z) in the formula (7). That is, in the present embodiment, when the DNN is constituted by the optical signal circuit, the local refractive index n(x,z) is controlled on the basis of the analogy discussed above, to adjust the weights for learning, for example.

While computation is performed in the real number region in a common neural network, computation is performed in the complex region in an optical circuit. NPL 5 reports that the expressive power is improved by expansion to the complex space, and a similar effect is expected from the present configuration. However, there is a difference that a non-linear function f is applied in the formula (2), while non-linear conversion is not included in the Hamiltonian in the formula (4). Thus, when consideration is given to the case where the system has two-dimensional linearity, for example, the Hamiltonian is indicated as follows.

$${H}_{NL} = \frac{1}{2 {kn}_{r}} \{ \frac{{\partial }^{2}}{\partial {x}^{2}} + V ( x , z ) + g {\vert ψ ( x , z ) \vert}^{2} \} \qquad ( 8 )$$

g is a constant related to non-linearity. Consequently, it is possible to apply non-linearity with the third term. While higher-order non-linearity is also conceivable, any case can be described using update rules to be discussed later in the present embodiment of the invention. From the above, it is seen that forward propagation in the optical circuit operates similarly to the DNN.

### Light Reception Unit

It is desirable in terms of signal processing to measure all the electric field Ψ(x,z1) of light propagated for a certain propagation length z1 in the circuit. In practice, however, it is preferable from the viewpoint of ease of manufacture to connect to photo detector (PD) arrays via a waveguide, because of problems such as the aperture of the PDs, the limit on the number of arrays, and the difficulty in coherent detection with multiple arrays. When consideration is given to the case where the intensity is received using a PD via an optical waveguide unit having a certain mode field φ(x), the received intensity η is indicated as follows.

ηᵢ=|∫Ψ(x,z₁)Φᵢ(x)dx|² (9)

It is considered that there are a plurality of PDs, and i is the number of the receiver. As is seen from the formula (7), it is possible to perform a non-linear conversion in accordance with the reception, even in the case where a linear optical circuit is used. Φ is given by the following Gaussian.

$${Φ}_{i} = \frac{1}{\sqrt{2 {κω}_{o}^{2}}} exp [ - \frac{{( x - {ix}_{p} )}^{2}}{{ω}_{o}^{2}} ] \qquad ( 10 )$$

ωₒ is the radius of the aperture, and xₚ is the center coordinate of the reception waveguide.

### Learning

Update, that is, learning, of the refractive index n(x,z), which is the weight in the DNN, by the optical circuit according to the present embodiment described above will be described. In the DNN, in general, a differential value (dL/dω) of each weight ω for a cost function L desired to be minimized is calculated using an error back propagation method, and the weight is updated using the calculated value. Meanwhile, signal processing for forward propagation according to the present embodiment of the present invention is indicated by the evolution equation indicated by the formula (3), and weight optimization by the error back propagation method for the DNN, which is discretized and normally used, cannot be used. In the case of such a continuous DNN, meanwhile, it is known that an adjoint method which is used to optimize the topology of a structure is equivalent to error back propagation [NPL 7]. Thus, consideration is given to the following variable called adjoint a(x,z). By calculating the formula (12) which is an evolution equation, a differential (dL/dn) of the loss function for the refractive index is calculated using the formula (13).

$$a ( x , z ) = \frac{\partial L}{\partial Ψ ( x , z )} \qquad ( 11 )$$

$$\frac{\partial a ( x , z )}{\partial z} = - a ( x , z ) \frac{\partial }{\partial Ψ ( x , z )} \{ - jH Ψ ( x , z ) \} = a ( x , z ) \{ jH + j \frac{\partial H}{\partial Ψ ( x , z )} Ψ ( x , z ) \} \qquad ( 12 )$$

$$\frac{\partial L}{\partial n ( {x}_{o} , {z}_{o} )} = {\int }_{{z}_{1}}^{{z}_{o}} a ( x , z ) \frac{\partial }{\partial n ( x , z )} \{ \frac{d ψ ( x , z )}{dz} \} dz \qquad ( 13 )$$

By substituting the formulas (3) and (4), update of the refractive index is given as follows.

$$\frac{\partial L}{\partial {n}_{real} ( x , z )} = {k}^{2} Im ( {\int }_{{z}_{1}}^{{z}_{o}} a ( x , z ) Ψ ( x , z ) dz ) \qquad ( 14 )$$

$$\frac{\partial L}{\partial {n}_{imag} ( x , z )} = {k}^{2} Re ( {\int }_{{z}_{1}}^{{z}_{o}} a ( x , z ) Ψ ( x , z ) dz ) \qquad ( 15 )$$

nᵣₑₐₗ and ni_{mag} indicate the real part and the imaginary part, respectively, of the refractive index. The real part corresponds to local variations in the phase, and the imaginary part corresponds to the loss and the gain. From the above, a differential value of the refractive index can be determined using the electric field Ψ(x,z) obtained during forward propagation and a(x,z) obtained by solving the adjoint equation (12). This calculation can be made by calculating a value at a(x,z1) from the formula (11) and using the resulting value as the initial value. In the case where the intensity is received via a PD as indicated by the formula (7), on the other hand, an initial value cannot be determined directly from the formula (11). In such a case, an initial value can be calculated using a chain rule of differentiation.

$$a ( x , {z}_{1} ) = \frac{\partial L}{\partial Ψ ( x , {z}_{1} )} = {\sum }_{i}^{N} \frac{\partial {η}_{i}}{\partial Ψ ( x , {z}_{1} )} \frac{\partial L}{\partial {η}_{i}} \qquad ( 16 )$$

$$\frac{\partial {η}_{i}}{\partial Ψ ( x , {z}_{1} )} = 2 Ψ ( x , {z}_{1} ) Re \{ {Φ}_{i} ( x ) \} \qquad ( 17 )$$

Consequently, the refractive index can be updated even in the case of intensity reception. Consideration is given to the case where teaching signals dᵢ and ηᵢ of the same dimension are compared and the refractive index is updated such that the signals are brought as close as possible to each other as a specific example. In this case, the loss function L may be considered as the following square error, for example.

L=Σᵢ^{N}(dᵢ−ηᵢ)² (18)

A differential of this is as follows.

$$\frac{\partial L}{\partial {η}_{i}} = 2 ( {d}_{i} - {η}_{i} ) \qquad ( 19 )$$

a(x, z₁) can be determined by substituting the formulas (17) and (19) into (15). By using the resulting value as the initial value, a(x,z) is calculated using the formula (12), and the gradient of the refractive index can be determined using the formulas (14) and (15). A variety of optimization methods which are used for an ordinary DNN can be used as an update method. In a stochastic gradient descent method, for example, N(N=128) pieces of learning data are extracted, and a gradient is calculated for each piece of data, and updated as indicated by the following formula (20).

$$n ← n - α {\sum }_{i}^{N} \frac{\partial {L}_{i}}{\partial n ( x , z )} \qquad ( 20 )$$

While the convolutional filter described above is described in one-dimensional notation for simplicity, two-dimensional or higher-order convolutional computation can be similarly expressed by a partial differential equation (NPL 6). In this case, the dimension of the Schrodinger equation may be expanded in accordance with the dimensions to be considered, in accordance with the degrees of freedom that light waves may have (x, y, z space, polarized waves, time, wavelength). Also for the optical implementation to be discussed later, one-dimensional convolutional computation is performed using a two-dimensional waveguide. However, a three-dimensional waveguide structure etc. may be used in accordance with the expanded dimensions.

With the method described above, it is possible to simulate the configuration of a DNN by locally controlling the refractive index distribution using the fact that the law of light propagation and propagation of the DNN are equivalent to each other. The local distribution of the refractive index can be controlled in the order of several tens of nanometers to micrometers, and thus it is possible to apply about 10⁶ to 10⁸ weights in an area of 1 mm by 1 mm. Light waves cannot be resolved with a refractive index distribution finer than the effective wavelength of propagated light, and therefore the average refractive index is the sensed refractive index of the light waves (effective medium approximation). This is effective because even a binary refractive index distribution can express an analog value in accordance with whether the refractive index distribution is coarse or dense, for example. However, it is desirable that the minimum dimension should be equal to or more than about one-tenth the optical wavelength, since a loss due to scattering etc. is also increased. If the refractive index distribution is coarse, meanwhile, the number of weights that can be placed inside the optical circuit is decreased. Therefore, it is desirable that the minimum dimension of the refractive index distribution should be equal to or less than about ten times the optical wavelength.

It may not be necessary to update both the real part and the imaginary part of the refractive index at all times, and it is only necessary to update at least one of such parts. The following effects can be achieved by particularly updating only the real part and making the imaginary part stationary at zero.

No loss is caused on the optical circuit, and no theoretical computation electric power is required.

With no theoretical loss, degradation in S/N along with an increase in the loss can be avoided.

The weight matrix corresponds to the unitary evolution, and therefore learning is stabilized.

### No Output Oscillation or No Chaos Transition

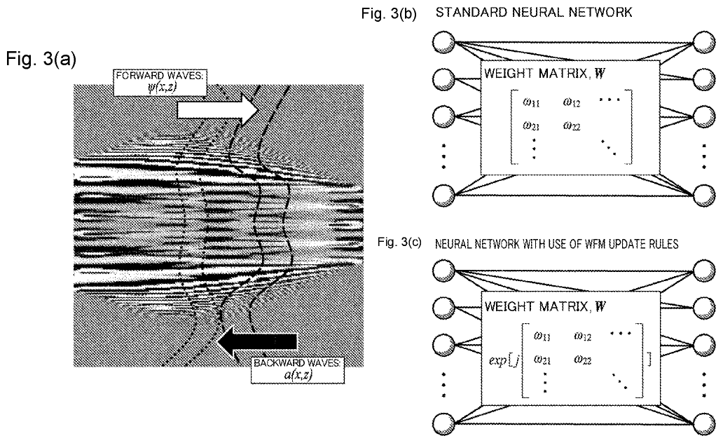

This corresponds to learning a neural network by a method called wavefront matching method (WFM) [NPL 5]. The difference from an ordinary neural network will be described with reference to FIGS. 3(a) to 3(c).

FIG. 3(a) is a schematic view of learning based on WFM, FIG. 3(b) illustrates an ordinary neural network, and FIG. 3(c) illustrates a neural network with use of WFM update rules. The difference between the DNN learning and the WFM learning illustrated in FIGS. 3(b) and 3(c) is that n_{imag} and the formula (21) are set to 0.

$$\frac{\partial L}{\partial nimag} \qquad ( 21 )$$

In the WFM, update is performed in accordance with the wavefronts of forward waves and backward waves. The amplitude of the waves is kept.

$$\frac{\partial L}{\partial {V ( x , z )}_{real}} ∝ Im [ ψ ( x , z ) a ( x , z ) ] \qquad ( 22 )$$

$$\frac{\partial L}{\partial {V ( x , z )}_{imag}} ∝ Re [ ψ ( x , z ) a ( x , z ) ] ≡ 0 \qquad ( 23 )$$

Ψ in the formulas (22) and (23) is the electric field of light propagated forward. a(x,z) corresponds to how the electric field is when light is introduced to the optical circuit from the reverse side. When the case where the circuit is linear (dH/dΨ=0) is considered, for example, it can be understood that the Schrodinger equation is simply time-reversed (in this case, evolved in reverse in the z direction). The formulas (22) and (23) evaluate overlap, and update the refractive index distribution in accordance with the difference. In essence, the formulas mean the same as the error back propagation of a neural network being performed in the complex space and in a continuously evolving manner.

When this method is used, the system becomes unstable in the case where max|eigin(W)|>1 in the standard neural network in FIG. 3(b). Energy-saving rules are not met.

In the neural network with use of WFM update rules in FIG. 3(c), W is a unitary matrix, and the system maintains stability at all times. The weight matrix which derives from the local refractive index means a Hamiltonian matrix. Energy-saving rules are met, and it is considered that there is no significant energy consumption.

With the present embodiment, it is possible to construct a DNN in which a local refractive index corresponds to a weight, rather than a conventional optical DNN in which MZIs are arranged, by using an optical signal processing device that constitutes a neural network, characterized by including an optical computation device including: a light modulator that converts an electric signal into an optical signal; an optical circuit that converts the optical signal through computation processing on the optical signal which has been modulated by the light modulator, the optical circuit including an optical medium with a controlled distribution of a refractive index corresponding to a weight in the neural network; and a light receiver that obtains an output signal by receiving the optical signal which has been converted by the optical circuit.

### Second Embodiment

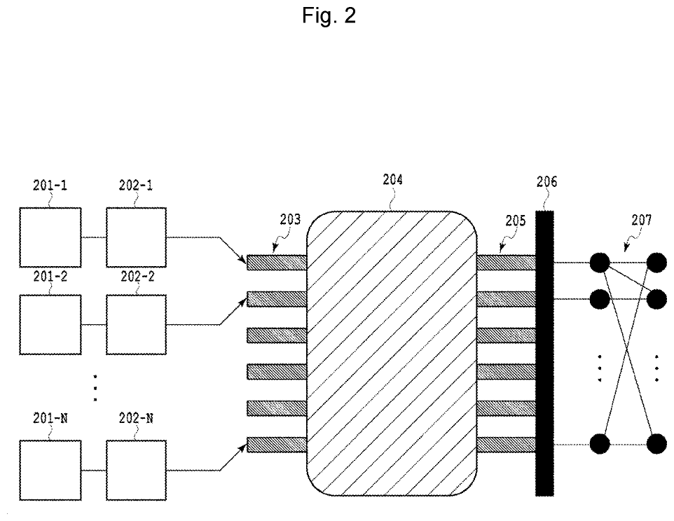

While all the neural signal processing is performed by an optical circuit unit in the first embodiment discussed above, the neural signal processing may be performed in a shared manner with an ordinary neural network which performs computation using a digital electronic circuit (an electric computation circuit that performs digital signal processing) etc. A second embodiment which is such an example will be described with reference to FIG. 2. Continuous laser emitted from light sources 201-N(N is a natural number) is modulated in one or both of the intensity and phase values of light waves by light modulators (light modulation means) 202-N(N is a natural number). Input information is expressed in this manner. Data having a plurality of dimensions, such as image information, may be expressed by a plurality of methods such as those discussed in relation to the first embodiment, and any multiplex system may be used.

The modulated optical signals are led to an optical circuit 204 with a controlled refractive index distribution via light propagation units 203. Optical computation is performed in this circuit, and the result of the optical computation is led to a light reception unit 206 via light propagation units 205 provided at an output end. An optical fiber array, an optical waveguide formed in the optical circuit 204, etc., for example, may be used as the light propagation units 203 and 205. A photodiode array etc. may be used as the light reception unit 206. Means may be provided for measuring not only the light intensity but also the phase and the polarization direction by causing a coherent light source to interfere with the light reception unit. In addition, means may be provided for measuring an optical signal for each wavelength using a wavelength separation element. Consequently, it is possible to separate light multiplexed by the variety of systems discussed earlier, and to also impart a plurality of dimensions of degrees of freedom to output data.

The received light is input to a neural network 207 in a digital computation circuit. In the computation circuit, computation (e.g. non-linear conversion, full connection, convolutional computation, etc.) performed by a common DNN is performed to obtain an output. With the present configuration, computation can be performed via digital computation, even for problems that cannot be fully solved easily through optical computation because of a constraint due to the scale of the optical circuit etc. In addition, an optical computation unit does not require electric power for theoretical computation, and therefore a good function is exhibited that electric power consumed for computation is reduced compared to the case where all computation is performed through digital computation in the electric region.

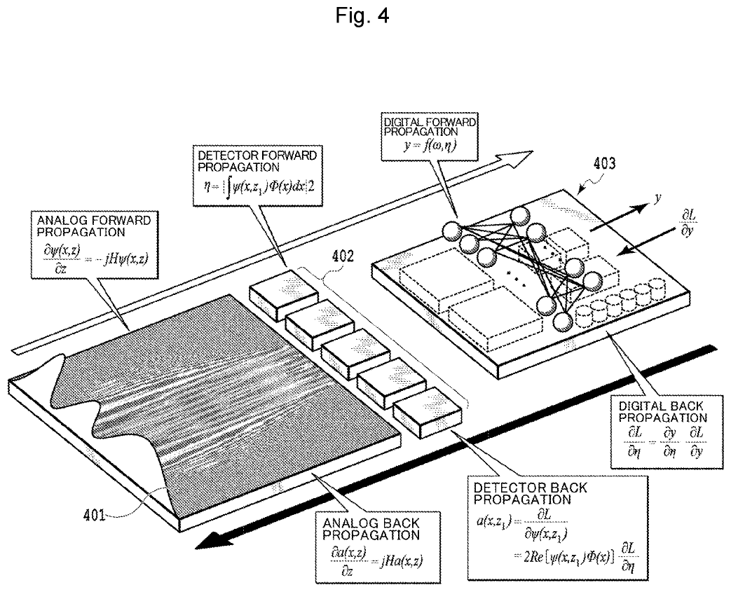

FIG. 4 illustrates an optical signal processing device that includes an analog optical circuit 401, light detectors 402, and a digital electronic circuit 403.

The relational expressions for analog, detector, and digital forward propagation and back propagation are indicated in FIG. 4. In the forward propagation process, light is first propagated forward in the optical circuit, and then received by the PDs, and outputs of the PDs are propagated forward by the neural network. In the back propagation process, on the other hand, a cost L is first defined by comparing an output and a desired output, and subjected to digital error back propagation, and then back propagation from the PDs to the optical circuit is calculated in accordance with a chain rule, and the error signal propagated from the PDs is propagated backward in the optical circuit.

The update method is generally the same as in the first embodiment. Since an output is made via the neural network on the electronic circuit, however, dL/dη cannot be determined directly as indicated by the formula (19), for example. Thus, as illustrated in FIG. 4, the refractive index is updated by calculating dL/dη via error back propagation from the neural network in the digital region. A DNN output Y is converted into a loss L using a cost function. Backward propagation of L is calculated using the standard formula for backward waves, and the formula of digital backward waves in FIG. 4 is obtained. The relational expression for detector forward propagation corresponds to the formula (7), and the relational expression for analog forward propagation corresponds to the formula (3).

With the present embodiment, it is possible to construct a DNN in which a local refractive index corresponds to a weight, rather than a conventional optical DNN in which MZIs are arranged, by using an optical signal processing device characterized by placing an electric computation circuit, which obtains an output by performing computation performed by a deep neural network, after an optical computation device.

While an optical signal processing device characterized by placing an electric computation circuit, which obtains an output by performing computation performed by a deep neural network, after an optical computation device is used in the present embodiment, an electric computation circuit, which obtains an output by performing computation performed by a deep neural network, may be placed before an optical computation device.

### Third Embodiment

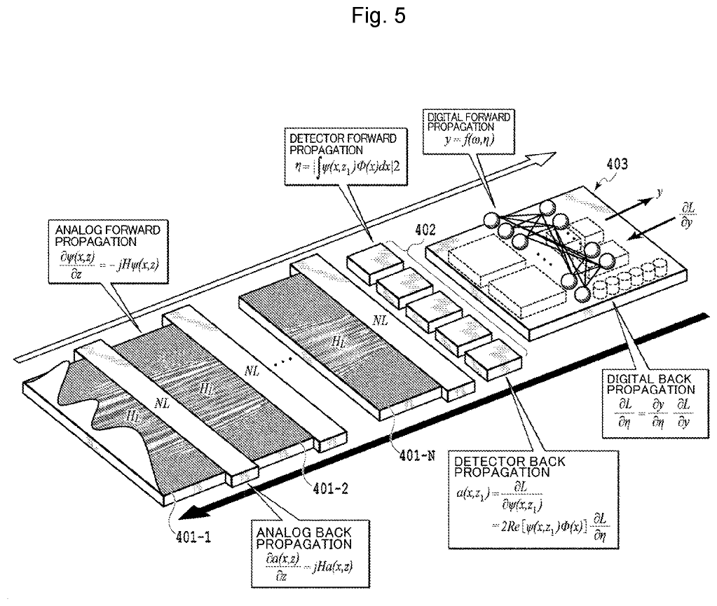

While a single optical computation unit is provided in the first and second embodiments, a plurality of optical computation units may be connected as illustrated in FIG. 5. FIG. 5 illustrates an optical signal processing device that includes analog optical circuits 401-N(N is a natural number), light detectors 402, and a digital electronic circuit 403. The drawing illustrates a flow of optical analog computation by the optical circuits and electric digital computation. The drawing illustrates a Hamiltonian-system, N-divided SE-NET (neural network based on the Schrodinger equation) having a non-linear layer. As in FIG. 4, the relational expressions for analog, detector, and digital forward propagation and back propagation are indicated in FIG. 5. In this case, a good function is exhibited that the processing performance is improved compared to a single optical circuit. The design method for this case is the same as the method described in relation to the first and second embodiments.

While a plurality of analog optical circuits are provided and the plurality of analog optical circuits are connected in series with each other in the present embodiment, the plurality of analog optical circuits may be connected in parallel with each other.

Algorithms such as CNN (Convolution Neural Network), LSTM (Long Short-Term Memory), GAN (Generative Adversarial Network), Deep Reinforcement Learning (DQN (Deep Q-Network), A3C (Asynchronous Advantage Actor-Critic), and A2C (Actor-Critic)) can be applied to the optical signal processing devices according to the first to third embodiments.

### Design Example

An example of optical circuit design according to the embodiments discussed above will be described. A task of classifying iris species data called “IRIS”, which are commonly used in machine learning tests, into species is performed. The input data include four-dimensional scalar amounts including “sepal length”, “sepal width”, “petal length”, and “petal width”. The purpose of this task is to classify the data into three species that belong to the iris genus, namely setosa, versicolor, and versinica. The optical computation circuit was constituted of a glass material with a non-refractive index of 1.45 and a loss of 0.01 dB/cm, and consideration was given to the case where only the real part of the refractive index was locally changed. The input expressed four dimensions through spatial multiplexing, the distance between the input waveguides was 6 μm, and the distance between the input waveguides was linear with Hamiltonian (in the case of the formula (4)). Of all the data (150), 75% was data for training, and 25% was data for verification. The refractive index distribution was controlled in 1 μm by 1 μm, and the refractive index distribution was controlled in 50 μm by 50 μm as a whole.

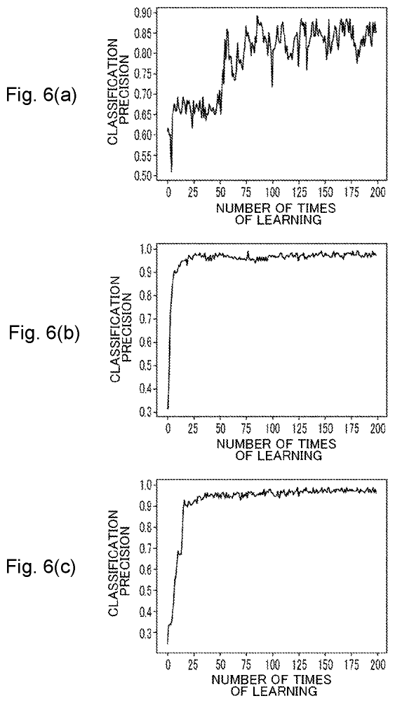

FIG. 6(a) illustrates the result (corresponding to the first embodiment) of classification with the number of PDs being three and with only one optical computation circuit. FIG. 6(b) illustrates the result (corresponding to the third embodiment) with three optical circuits cascaded. FIG. 6(c) illustrates the result for a case (corresponding to the third embodiment) where the number of PDs is 10 and outputs from the PDs are computed using a fully connected neural network of 10×3 in the electric region. It is seen that learning was executed by the method according to the present invention, since classification was executed with a precision higher than 85% in each case. It is also seen that the performance was effectively improved by taking the configuration according to the second or third embodiment, since the classification precision was improved to be higher than 98%. The third embodiment was generally equivalent in the performance to the second embodiment, but had the effect of reducing electric power for computation since digital computation was not required.

1. An optical signal processing device that constitutes a neural network, characterized by comprising
an optical computation device including:
a light modulator that converts an electric signal into an optical signal;
an optical circuit that converts the optical signal through computation processing on the optical signal which has been modulated by the light modulator, the optical circuit including an optical medium with a controlled distribution of a refractive index corresponding to a weight in the neural network; and
a light receiver that obtains an output signal by receiving the optical signal which has been converted by the optical circuit.

2. The optical signal processing device according to claim 1, wherein
an electric computation circuit that obtains an output by performing computation performed by the neural network is provided at least before or after the optical computation device.

3. The optical signal processing device according to claim 1, wherein:
a plurality of optical circuits are provided; and
the plurality of optical circuits are connected in series or in parallel with each other.

4. The optical signal processing device according to claim 1, wherein
the optical medium is a two-dimensional waveguide with a controlled distribution of the refractive index in a propagation surface.

5. The optical signal processing device according to claim 1, wherein
a minimum dimension of the distribution of the refractive index is equal to or more than one-tenth of a wavelength of input light and equal to or less than ten times the wavelength of the input light.

6. The optical signal processing device according to claim 1, wherein
the refractive index is designed by making an imaginary part of the refractive index stationary at zero and changing only a real part of the refractive index.

7. The optical signal processing device according to claim 2, wherein:
a plurality of optical circuits are provided; and
the plurality of optical circuits are connected in series or in parallel with each other.

8. The optical signal processing device according to claim 2, wherein
the optical medium is a two-dimensional waveguide with a controlled distribution of the refractive index in a propagation surface.

9. The optical signal processing device according to claim 3, wherein
the optical medium is a two-dimensional waveguide with a controlled distribution of the refractive index in a propagation surface.

10. The optical signal processing device according to claim 2, wherein
a minimum dimension of the distribution of the refractive index is equal to or more than one-tenth of a wavelength of input light and equal to or less than ten times the wavelength of the input light.

11. The optical signal processing device according to claim 3, wherein
a minimum dimension of the distribution of the refractive index is equal to or more than one-tenth of a wavelength of input light and equal to or less than ten times the wavelength of the input light.

12. The optical signal processing device according to claim 4, wherein
a minimum dimension of the distribution of the refractive index is equal to or more than one-tenth of a wavelength of input light and equal to or less than ten times the wavelength of the input light.

13. The optical signal processing device according to claim 2, wherein
the refractive index is designed by making an imaginary part of the refractive index stationary at zero and changing only a real part of the refractive index.

14. The optical signal processing device according to claim 3, wherein
the refractive index is designed by making an imaginary part of the refractive index stationary at zero and changing only a real part of the refractive index.

15. The optical signal processing device according to claim 4, wherein
the refractive index is designed by making an imaginary part of the refractive index stationary at zero and changing only a real part of the refractive index.

16. The optical signal processing device according to claim 5, wherein
the refractive index is designed by making an imaginary part of the refractive index stationary at zero and changing only a real part of the refractive index.
